(19) United States
(12) Patent Application Publication
(10) Pub. No.: US 2025/0277838 A1
(43) Pub. Date: Sep. 4, 2025

(54) ANALYSIS METHOD AND DESIGN METHOD FOR MULTICONDUCTOR TRANSMISSION LINE SYSTEM

(71) Applicant: TOYOTA JIDOSHA KABUSHIKI KAISHA, Toyota-shi (JP)

(72) Inventors: Noboru MAEDA, Chiryu-shi (JP); Keishi MIWA, Nagoya-shi (JP)

(73) Assignee: TOYOTA JIDOSHA KABUSHIKI KAISHA, Toyota-shi (JP)

(21) Appl. No.: 19/039,268

(22) Filed: Jan. 28, 2025

(30) Foreign Application Priority Data
Feb. 29, 2024 (JP) 2024-030142

(51) Int. Cl. G01R 29/26; G06F 30/20; G06F 113/16; G06F 119/10

(52) U.S. Cl. CPC G01R 29/26; G06F 30/20; G06F 2113/16; G06F 2119/10

(57) ABSTRACT

An analysis method and a design method for a multiconductor transmission line system are provided. One or more conductor lines include a branching section extending from a parallel section. One or more change positions for a characteristic impedance of the conductor lines include one or more branching sections. Each of the conductor lines is assumed to be routed back and forth between a first terminal circuit network and a second terminal circuit network using the one or more change positions for the characteristic impedance as one or more fold-back points. A design value of a specific component of components in the multiconductor transmission line system is modified such that the characteristic impedance of the specific component changes.

### CROSS-REFERENCE TO RELATED APPLICATIONS

This application is based upon and claims the benefit of priority from Japanese Patent Application No. 2024-030142, filed on Feb. 29, 2024, the entire contents of which are incorporated herein by reference.

### BACKGROUND

### 1. Field

The present disclosure relates to an analysis method and a design method for a multiconductor transmission line system.

### 2. Description of Related Art

Examples of multiconductor transmission line systems include, for example, vehicle on-board wire harnesses and pattern wiring on circuit boards. That is, the multiconductor transmission line system includes a ground plane and conductor lines. In the multiconductor transmission line system, noise can become apparent due to resonance. Japanese Laid-Open Patent Publication No. 2019-55686 discloses an example of a technique for suppressing the manifestation of noise in vehicle on-board wire harnesses.

The technique disclosed in the above-described document is employed only in vehicle on-board wire harnesses in which wires are bundled into one. Accordingly, the technique disclosed in the document cannot be employed in multiconductor transmission line systems that include branched wiring.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides an analysis method for a multiconductor transmission line system. The analysis method includes providing the multiconductor transmission line system. The multiconductor transmission line system includes a ground plane and conductor lines. The multiconductor transmission line system further includes a parallel section in which the conductor lines are arranged parallel to each other. Each of the conductor lines includes a terminal load. One or more of the conductor lines include one or more branching sections extending from the parallel section. The conductor lines include one or more change positions for characteristic impedance that include the one or more branching sections A noise propagation model is assumed. The noise propagation model includes a uniform line group, a first terminal circuit network, and a second terminal circuit network. A noise signal that has been input into the multiconductor transmission line system is assumed to propagate while undergoing multiple reflections between the first terminal circuit network and the second terminal circuit network via the uniform line group. Routing of the conductor lines in the noise propagation model is assumed. Each of the conductor lines is assumed to be routed back and forth between the first terminal circuit network and the second terminal circuit network using the one or more change positions for the characteristic impedance as one or more fold-back points. Each of the one or more fold-back points includes a fold-back terminal element. The uniform line group is formed with uniform lines. Each of the conductor lines includes the uniform lines spanning between the first terminal circuit network and the second terminal circuit network. The uniform line group includes a first group terminal corresponding to the first terminal circuit network and a second group terminal corresponding to the second terminal circuit network. The first terminal circuit network is formed by one or more of the terminal loads connected to the first group terminal and one or more of the fold-back terminal elements connected to the first group terminal. The second terminal circuit network is formed by one or more of the terminal loads connected to the second group terminal and one or more of the fold-back terminal elements connected to the second group terminal. A noise characteristic of the multiconductor transmission line system is analyzed using the noise propagation model.

Another aspect of the present disclosure provides a design method for a multiconductor transmission line system. The design method includes analyzing eigenvalues of components of the multiconductor transmission line system by analyzing a noise characteristic of the multiconductor transmission line system using a noise propagation model. A specific component is extracted from the components based on a result of analyzing the eigenvalues. The specific component has an eigenvalue that is greater than the eigenvalues of other ones of the components in a problematic frequency. A design value of the specific component is modified such that the characteristic impedance of the specific component changes.

A further aspect of the present disclosure provides a design method for a multiconductor transmission line system. The design method includes calculating a peak frequency of noise in one or more of components of the multiconductor transmission line system by analyzing a noise characteristic of the multiconductor transmission line system using a noise propagation model. Each of the uniform lines has a height from the ground plane. The one or more of the heights is changed when the peak frequency is a problematic frequency.

The above-described analysis method for the multiconductor transmission line system simplifies the analysis of the noise characteristics of the multiconductor transmission line system, which has branches. The above-described design method for the multiconductor transmission line system allows the multiconductor transmission line system to be designed effectively.

Suppression of noise in multiconductor transmission line systems needs the analysis of the noise characteristics. However, a simple method for analyzing the noise characteristics in multiconductor transmission line systems with branches has not yet been generally established. This makes it difficult to design a multiconductor transmission line system capable of suppressing the manifestation of noise. The above-described methods reduce such difficulties.

Other features and aspects will be apparent from the following detailed description, the drawings, and the claims.

### BRIEF DESCRIPTION OF THE DRAWINGS

FIG. 1 is a schematic diagram illustrating an example of the configuration of a multiconductor transmission line system.

FIG. 2 is a circuit diagram of a noise propagation model in which noise signals propagate through the multiconductor transmission line system shown in FIG. 1.

FIG. 3 is a schematic diagram illustrating another example of the configuration of the multiconductor transmission line system.

FIG. 4 is a circuit diagram of a noise propagation model in which noise signals propagate through the multiconductor transmission line system shown in FIG. 3.

FIG. 5 is a schematic diagram illustrating a further example of the configuration of the multiconductor transmission line system.

FIG. 6 is a circuit diagram of a noise propagation model in which noise signals propagate through the multiconductor transmission line system shown in FIG. 5.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

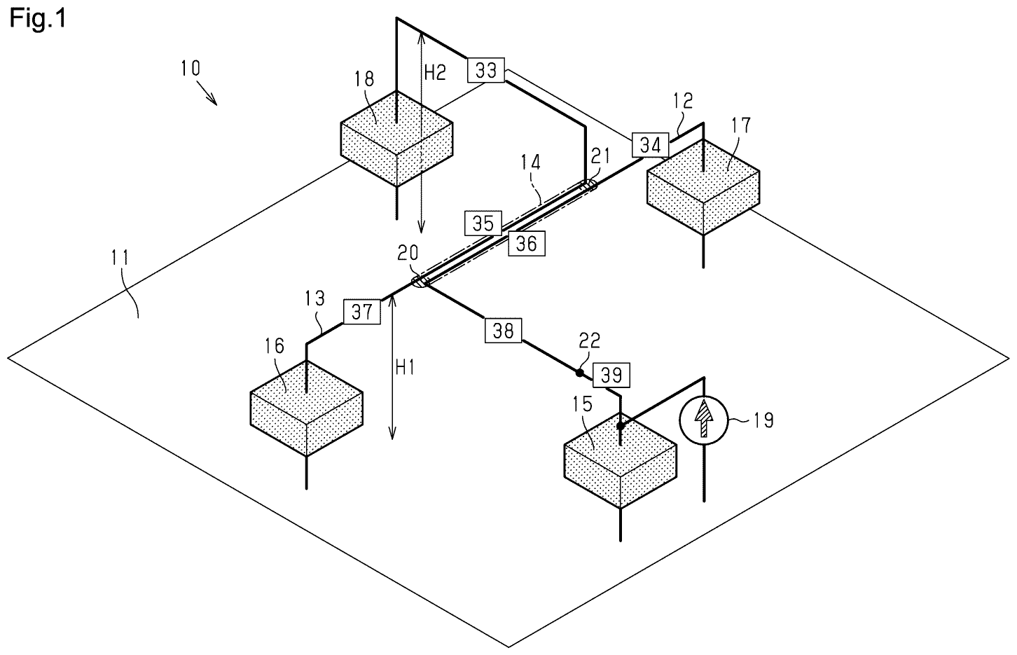

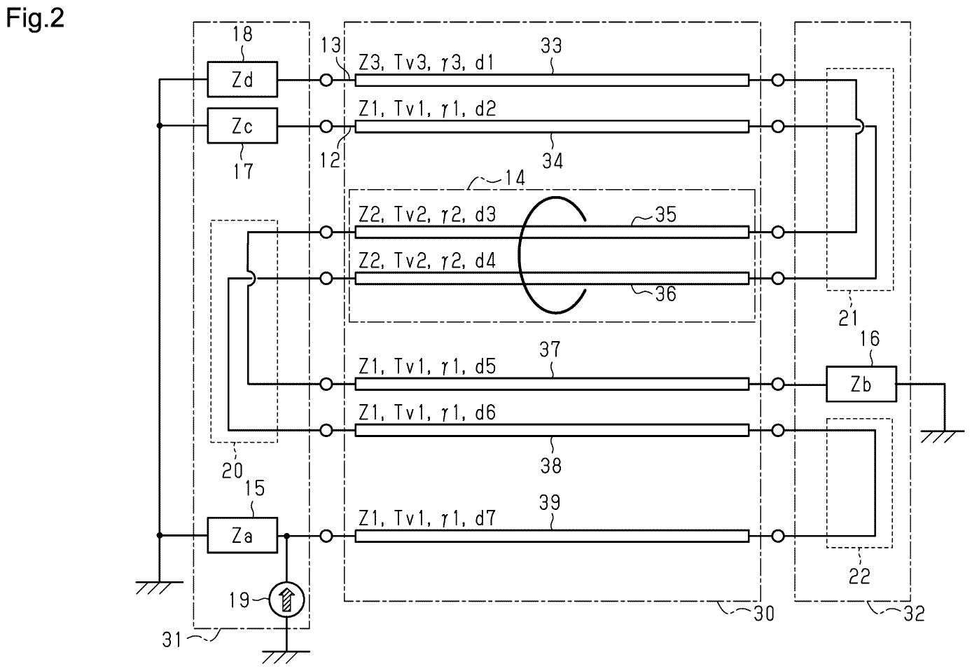

FIGS. 1 and 2 illustrate an analysis method for a multiconductor transmission line system according to an embodiment.

### Configuration of Multiconductor Transmission Line System

The configuration of the multiconductor transmission line system according to the present embodiment will now be described with reference to FIG. 1. The multiconductor transmission line system is subject to analysis for noise characteristics.

As shown in FIG. 1, the multiconductor transmission line system 10 includes a ground plane 11 and two conductor lines. The two conductor lines include a first conductor line 12 and a second conductor line 13 laid on the ground plane 11. The material and cross-sectional shape of the conductor and coated dielectric that form the first conductor line 12 are identical to those of the second conductor line 13. The multiconductor transmission line system 10 includes a parallel section 14 in which the first conductor line 12 and the second conductor line 13 are arranged parallel and adjacent to each other. The first conductor line 12 and the second conductor line 13 branch off from each other at two ends of the parallel section 14. Hereinafter, the first end of the parallel section 14 will be referred to as the first branching section 20, and the second end of the parallel section 14 is referred to as the second branching section 21. The portion of each of the first conductor line 12 and the second conductor line 13 that branches from the parallel section 14 and is laid out solely as the first conductor line 12 or the second conductor line 13 will be referred to as a single-line section.

The first terminal of the first conductor line 12 is grounded to the ground plane 11 through a first terminal load 15. The second terminal of the first conductor line 12 is grounded to the ground plane 11 through the third terminal load 17. The first terminal of the second conductor line 13 is grounded to the ground plane 11 through the second terminal load 16. The second terminal of the second conductor line 13 is grounded to the ground plane 11 through the fourth terminal load 18. The majority of the first conductor line 12 and the second conductor line 13 is laid at a position of the first height H1 from the ground plane 11. In other words, the majority of the first conductor line 12 and the second conductor line 13 is positioned at a fixed height from the ground plane 11. The part of the first conductor line 12 and the second conductor line 13 that deviates in height is the section of the second conductor line 13 between the second branching section 21 and the fourth terminal load 18. The part of the second conductor line 13 that deviates in height is laid at a position of the second height H2 (>H1) from the ground plane 11. For illustrative purposes, the lengths of the lines in FIG. 1 that extend in a direction perpendicular to the ground plane 11, among the lines representing the first conductor line 12 and the second conductor line 13, indicate the height from the ground plane 11 rather than the physical lengths of the first conductor line 12 and the second conductor line 13.

In the multiconductor transmission line system 10 shown in FIG. 1, the first terminal load 15 is located at the first terminal of the first conductor line 12. A noise source 19 is connected to the first terminal of the first conductor line 12. The noise source 19 indicates, for example, a noise source included in the first terminal load 15. As another example of the noise source 19, noise generated in the first conductor line 12 by induction due to external noise is represented as an equivalent terminal noise source.

Examples of the multiconductor transmission line system 10 to be provided include wire harnesses and busbar modules. These wire harnesses and busbar modules are installed in transportation equipment, such as vehicles and aircraft. In this case, the ground plane 11 is a conductor body of the transportation equipment. The first conductor line 12 and the second conductor line 13 are electric wires or busbars. Another example of the multiconductor transmission line system 10 is the wiring pattern of a circuit board. In this case, the ground plane 11 is a solid ground plane of the circuit board. The first conductor line 12 and the second conductor line 13 are the pattern wiring of the circuit board.

### Noise Propagation Model of Multiconductor Transmission Line System

In the analysis method of the present embodiment, the noise propagation model in FIG. 2 is used to analyze the noise characteristics of the multiconductor transmission line system 10 shown in FIG. 1. The noise propagation model in FIG. 2 is obtained by replacing the multiconductor transmission line system 10 in FIG. 1 with a multiconductor transmission line system where non-branching lines are placed in parallel. That is, the multiconductor transmission line system shown in FIG. 2 models the propagation of noise.

FIG. 2 illustrates a replacement circuit for the multiconductor transmission line system 10 shown in FIG. 1. The replacement circuit in FIG. 2 is used for the noise propagation model. The replacement circuit in FIG. 2 is formed by a first terminal circuit network 31, a second terminal circuit network 32, and a uniform line group 30. The uniform line group 30 spans between the first terminal circuit network 31 and the second terminal circuit network 32. The replacement circuit in FIG. 2 is created by replacing the multiconductor transmission line system 10, which is shown in FIG. 1, in the following manner.

It is assumed that the first conductor line 12 and the second conductor line 13 are routed back and forth between the first terminal circuit network 31 and the second terminal circuit network 32. One or more fold-back points of the first conductor line 12 or the second conductor line 13 in the first terminal circuit network 31 or the second terminal circuit network 32 are change positions for the characteristic impedance of the first conductor line 12 or the second conductor line 13. In other words, at the change positions for the characteristic impedance, the characteristic impedance of either the first conductor line 12 or the second conductor line 13 changes. The change positions for the characteristic impedance include branching sections from the parallel section 14; specifically, the first branching section 20 and the second branching section 21. In the multiconductor transmission line system 10 shown in FIG. 1, the change positions for the characteristic impedance of the first conductor line 12 and the second conductor line 13 include the first branching section 20 and the second branching section 21. The change positions for the characteristic impedance of the first conductor line 12 and the second conductor line 13 include a section of the first conductor line 12 and the second conductor line 13 where the cross-sectional shape of the conductor of the conductor line changes and a section where the height from the ground plane 11 changes. Parallel uniform lines 33 to 39 span between the first terminal circuit network 31 and the second terminal circuit network 32. As described above, for replacement with the replacement circuit shown in FIG. 2, the first conductor line 12 and the second conductor line 13 are folded back at the change positions for the characteristic impedance. The characteristic impedance of each of the uniform lines 33 to 39 remains uniform throughout the entire lengths of the uniform line 33 to 39. That is, the uniform lines 33 to 39 span in parallel between the first terminal circuit network 31 and the second terminal circuit network 32. The uniform lines 33 to 39 form the uniform line group 30. The uniform line group 30 includes a first group terminal corresponding to the first terminal circuit network 31 and a second group terminal corresponding to the second terminal circuit network 32.

In FIG. 2, the first terminal circuit network 31 includes the noise source 19. Thus, the first conductor line 12 is further folded back at an intermediate position of the single-line section between the first terminal load 15 and the first branching section 20. In the following description, this fold-back position is referred to as a fold-back point 22. The line length of the section of the first conductor line 12 between the noise source 19 and the first terminal load 15 on one side and the fold-back point 22 on the other side is set to be sufficiently smaller than the line length of the section between the first branching section 20 and the fold-back point 22. In this context, the first terminal load 15 and the noise source 19 are treated as a single entity. In such a noise propagation model, the first terminal circuit network 31 includes the first terminal load 15, the third terminal load 17, the fourth terminal load 18, the first branching section 20, and the noise source 19. The first terminal load 15, the third terminal load 17, and the fourth terminal load 18 are connected to the first group terminal of the uniform line group 30. The first branching section 20 and the noise source 19 are fold-back terminal elements connected to the first group terminal of the uniform line group 30. That is, the first terminal circuit network 31 includes the first terminal load 15, the third terminal load 17, and the fourth terminal load 18, which are connected to the first group terminal of the uniform line group 30, and includes the first branching section 20 and the noise source 19, which serve as the fold-back terminal elements connected to the first group terminal of the uniform line group 30. The second terminal circuit network 32 includes the fold-back point 22, the second terminal load 16, and the second branching section 21. The first branching section 20, the second branching section 21, and the fold-back point 22 are represented as short-circuit lines connecting the terminals of two of the uniform lines 33 to 39 to each other. The second terminal load 16 is connected to the second group terminal of the uniform line group 30. The second branching section 21 and the fold-back point 22 are fold-back terminal elements connected to the second group terminal of the uniform line group 30. That is, the second terminal circuit network 32 includes the second terminal load 16, which is connected to the second group terminal of the uniform line group 30, and the fold-back terminal elements (specifically, the second branching section 21 and the fold-back point 22), which are connected to the second group terminal of the uniform line group 30.

In FIG. 2, the uniform line group 30 includes seven uniform lines 33 to 39, which are arranged in parallel. The uniform line 33 corresponds to the section of the second conductor line 13 between the second branching section 21 and the fourth terminal load 18. In FIG. 1, the sections corresponding to the uniform lines 33 to 39 are labeled with the numbers 33 to 39, respectively. The uniform line 34 corresponds to the section of the first conductor line 12 between the second branching section 21 and the third terminal load 17. The uniform line 35 corresponds to the section of the second conductor line 13 between the first branching section 20 and the second branching section 21. The uniform line 36 corresponds to the section of the first conductor line 12 between the first branching section 20 and the second branching section 21. The uniform line 37 corresponds to the section of the second conductor line 13 between the second terminal load 16 and the first branching section 20. The uniform line 38 corresponds to the section of the first conductor line 12 between the fold-back point 22 and the first branching section 20. The uniform line 39 corresponds to the section of the first conductor line 12 between the first terminal load 15 and the noise source 19 on one side and the first branching section 22 on the other side. Among the uniform lines 33 to 39, the uniform lines 35 and 36 correspond to the parallel section 14. The other uniform lines 33 to 34 and 37 to 39 correspond to single-line sections.

In the present embodiment, for the analysis of noise characteristics, the multiconductor transmission line system 10 shown in FIG. 1 is replaced with the multiconductor transmission line system shown in FIG. 2. The multiconductor transmission line system 10 shown in FIG. 1 includes branches between the conductor lines. The multiconductor transmission line system shown in FIG. 2 includes no branches between the conductor lines. The noise characteristics are analyzed using the noise propagation model in the replaced multiconductor transmission line system. FIG. 2 illustrates the analysis of noise characteristics in the following multiconductor transmission line system. The multiconductor transmission line system in FIG. 2 includes multiple transmission lines and does not include branches between the transmission lines. The analysis of noise characteristics in a multiconductor transmission line system without branches is described in detail in the cited reference, Clayton R. Paul, “Analysis of Multiconductor Transmission Lines”, 2nd Edition, Wiley. In this specification, the analysis of noise characteristics in a multiconductor transmission line system without branches will be described briefly. Various computations for noise analysis are executed by, for example, a control device. The control device includes, for example, processing circuitry and a memory that stores a program that causes the processing circuitry to execute operations related to various computations.

To analyze noise characteristics, first, the per-unit-length impedance, the propagation constant, and the voltage mode conversion coefficient of each of the uniform lines 33 to 39 need to be determined. These values can be computed from, for example, the per-unit-length inductance and per-unit-length capacitance of each uniform line 33 to 39. The per-unit-length inductance and per-unit-length capacitance of each of the uniform lines 33 to 39 can be computed through electromagnetic field simulation that is based on the cross-sectional shapes of the conductors of the uniform lines 33 to 39.

In the present embodiment, the cross-sectional shapes of the conductors of the uniform lines 33 to 39 are identical to each other. Each of the uniform lines 33 to 34 and 37 to 39 is a single-line section, not a parallel section. In this case, the per-unit-length inductance of each of the uniform lines 33 to 34 and 37 to 39 is the same if they have the same height from the ground plane 11. Likewise, the per-unit-length capacitances have the same value. The uniform line 33 is laid at a position of the second height H2 from the ground plane 11. The uniform lines 34 and 37 to 39 are each laid at a position of the first height H1 from the ground plane 11. Thus, the per-unit-length impedance, propagation constant, and voltage mode conversion coefficient of each of the uniform lines 34 and 37 to 39 (other than the uniform line 33), which have the same height from the ground plane 11, have the same values. In the following description, the uniform lines 34 and 37 to 39 have a per-unit-length impedance referred to as Z1, a propagation constant referred to as γ1, and a voltage mode conversion coefficient referred to as Tv1. Further, the uniform line 33 has a per-unit-length impedance referred to as Z3, a propagation constant referred to as γ3, and a voltage mode conversion coefficient referred to as Tv3. In single-line sections, noise propagation modes can be regarded as singular. Thus, technically, each of the values of Tv1 and Tv3 is 1.

The uniform lines 35 and 36 are located in the parallel section 14. The per-unit-length impedance, propagation constant, and voltage mode conversion coefficient of the parallel section 14 are determined by capacitive coupling and mutual inductance coupling between the conductors of the uniform lines 35 and 36. Specifically, the per-unit-length impedance, propagation constant, and voltage mode conversion coefficient of the parallel section 14 can be determined through modeling as the multiconductor transmission line system. The per-unit-length impedance, propagation constant, and voltage mode conversion coefficient of the parallel section 14 are represented as 2×2 matrices. In the following description, the parallel section 14 has a per-unit-length impedance matrix referred to as Z2, a propagation constant matrix referred to as γ2, and a voltage mode conversion coefficient matrix referred to as Tv2. The per-unit-length impedance, propagation constant, and voltage mode conversion coefficient of a parallel section consisting of N uniform lines parallel to each other are represented as N×N matrices.

In the present embodiment, the electrical resistance of the conductor in each of the uniform lines 33 to 39 and the dielectric loss in wire coating or the like were sufficiently small. Therefore, these factors were disregarded, and the above-described parameters were computed. In cases where more precise computations are needed or where the electrical resistance and dielectric loss are too significant to disregard, the above-described parameters should be calculated considering the electrical resistance of the conductors and the dielectric loss in the wire coating or the like.

In practice, the values of the per-unit-length impedance, propagation constant, and voltage mode conversion coefficient exhibit frequency characteristics. However, in most practical applications, disregarding the frequency characteristics does not pose a problem. In the present embodiment, only the computation of the per-unit-length impedance takes the frequency characteristics into account. Specifically, the value of the per-unit-length impedance is calculated as a frequency-corrected value for the per-unit-length impedance at relatively low frequencies. The frequency correction takes the skin effect into account.

To analyze noise characteristics, the first terminal circuit network 31 and the second terminal circuit network 32 need to be expressed by a mode reflection coefficient matrix. The mode reflection coefficient matrix is expressed as follows.

First, the first terminal circuit network 31 is represented using admittance matrices Y1 and Y2 as shown in expressions (1) and (2), respectively. The diagonal elements of the admittance matrix Y1 are assigned admittances 1/Za, 1/Zc, and 1/Zd, respectively corresponding to the first terminal load 15, the third terminal load 17, and the fourth terminal load 18, which are included in the first terminal circuit network 31. The load element that connects between the uniform lines 33 to 39 in the first terminal circuit network 31 is a connection load element. The admittance 1/st of the connection load element is assigned as a diagonal element in the admittance matrix Y1. The sign-reversed value (−1/st) of the admittance of the connection load element is assigned as an off-diagonal element in the admittance matrix Y1. The portions enclosed by the dotted lines in the expression correspond to these connection load elements. The first terminal circuit network 31 includes connection load elements between the uniform lines 33 to 39. The connection load elements between the uniform lines 33 to 39 in the first terminal circuit network 31 include a short-circuit line between the uniform lines 35 and 37 at the first branching section 20 and a short-circuit line between the uniform lines 36 and 38. In practice, the inductance of these short-circuit lines is 0. However, if the inductance is 0, the admittance that corresponds to the magnitude of the reciprocal of the inductance can be infinite. Accordingly, the value of the inductance of these short-circuit lines are set to a value st, which is sufficiently smaller than inductances Za to Zd of the first to fourth terminal loads 15 to 18. Thus, the reciprocal of st is arranged in the admittance matrix Y1.

Expression 1

| | |
|---|---|
| 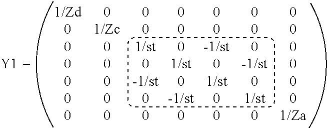 | (1) |

The second terminal circuit network 32 includes the second terminal load 16 as a load element connected to the terminals of the uniform lines 33 to 39. The second terminal circuit network 32 includes connection load elements between the uniform lines 33 to 39. The connection load elements between the uniform lines 33 to 39 in the second terminal circuit network 32 include a short-circuit line between the uniform lines 38 and 39 at the fold-back point 22. Additionally, the connection load elements include a short-circuit line between the uniform lines 33 and 35 and a short-circuit line between the uniform lines 34 and 36 at the second branching section 21. In the same manner as expression (1), the admittance matrix Y2 of the second terminal circuit network 32 can be determined as shown in expression (2) using the inductance value st of the short-circuit line.

Expression 2

| | |
|---|---|
| 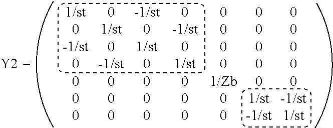 | (2) |

Next, as shown in expression (3), the per-unit-length impedance matrix Z for the entire uniform line group 30 is created. The diagonal elements of the per-unit-length impedance matrix Z are assigned the per-unit-length impedances of the uniform lines 33 to 39 in the uniform line group 30.

Expression 3

| | |
|---|---|
| 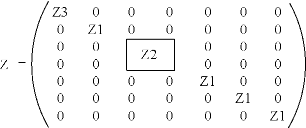 | (3) |

As shown in expression (4), the voltage mode conversion coefficient matrix Tv for the entire uniform line group 30 is created. The diagonal elements of the voltage mode conversion coefficient matrix Tv are assigned the voltage mode conversion coefficients of the uniform lines 33 to 39 of the uniform line group 30.

Expression 4

| | |
|---|---|
| 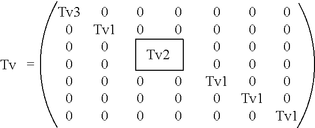 | (4) |

Further, as shown in expression (5), the propagation coefficient matrix y for the entire uniform line group 30 is created. The diagonal elements of the propagation coefficient matrix y are assigned the propagation coefficients of the uniform lines 33 to 39 of the uniform line group 30.

Expression 5

| | |
|---|---|
| 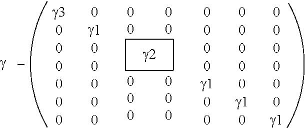 | (5) |

As shown in expression (6), a line length matrix d for the entire uniform line group 30 is created. The diagonal elements of the line length matrix d are assigned line lengths d1to d7 of the uniform lines 33 to 39 of the uniform line group 30.

$$\begin{matrix}Expression 6 & \\ d = ( \begin{matrix}d 1 & 0 & 0 & 0 & 0 & 0 & 0 \\ 0 & d 2 & 0 & 0 & 0 & 0 & 0 \\ 0 & 0 & d 3 & 0 & 0 & 0 & 0 \\ 0 & 0 & 0 & d 4 & 0 & 0 & 0 \\ 0 & 0 & 0 & 0 & d 5 & 0 & 0 \\ 0 & 0 & 0 & 0 & 0 & d 6 & 0 \\ 0 & 0 & 0 & 0 & 0 & 0 & d 7\end{matrix} ) & ( 6 )\end{matrix}$$

By using the above-described expressions, as shown in expression (7), the characteristic admittance matrix Y0 for the entire uniform line group 30 can be derived.

$$\begin{matrix}Expression 7 & \\ Y 0 = {Z}^{- 1} \cdot Tv \cdot γ \cdot {Tv}^{- 1} & ( 7 )\end{matrix}$$

The admittance matrix for the first terminal circuit network 31 is denoted as Y1, and the noise source 19 is denoted as a current source J. In this case, an actual input voltage wave Ass from the first terminal circuit network 31 is determined as the value shown in expression (8). When the noise source 19 is defined as a voltage source, the actual input voltage waveform Ass can be determined by converting the noise source 19 into a current source using a Norton equivalent circuit.

$$\begin{matrix}Expression 8 & \\ Ass = {( Y 0 + Y 1 )}^{- 1} \cdot {[ \begin{matrix}0 & ⋯ & 0 & J\end{matrix} ]}^{T} & ( 8 )\end{matrix}$$

The actual input voltage wave Ass can be transformed into a mode incident voltage wave vector Amss, as shown in expression (9).

$$\begin{matrix}Expression 9 & \\ Amss = {Tv}^{- 1} \cdot ass & ( 9 )\end{matrix}$$

An actual voltage reflection coefficient matrix S1 of the first terminal circuit network 31 is expressed in the form shown in expression (10).

$$\begin{matrix}Expression 10 & \\ S 1 = {( Y 0 + Y 1 )}^{- 1} \cdot ( Y 0 - Y 1 ) & ( 10 )\end{matrix}$$

When the actual voltage reflection coefficient matrix S1 is transformed into mode space, expression (11) is obtained. Expression (11) represents a mode reflection coefficient matrix Sm1 of the first terminal circuit network 31. Similarly, a mode reflection coefficient matrix Sm2 of the second terminal circuit network 32 can also be determined.

$$\begin{matrix}Expression 11 & \\ Sm 1 = {Tv}^{- 1} \cdot S 1 \cdot Tv & ( 11 )\end{matrix}$$

FIG. 2 illustrates the replacement circuit for the multiconductor transmission line system 10 shown in FIG. 1. The propagation of noise in the replacement circuit can be described by using the propagation of mode voltage waves in the uniform line group 30. The noise propagation can also be described by using the mode reflection in the first terminal circuit network 31 and the second terminal circuit network 32. In this case, the noise injected from the noise source 19 into the replacement circuit is the mode incident voltage wave vector Amss of expression (9). The injected noise circulates through the multiconductor transmission line system 10 by sequentially undergoing the following processes: (a) propagation through the uniform line group 30, (b) reflection at the second terminal circuit network 32, (c) propagation through the uniform line group 30, and (d) reflection at the first terminal circuit network 31. The attenuation and phase lag of noise during the noise propagation in (a) and (c) are determined as a vector AT shown in expression (12).

$$\begin{matrix}Expression 12 & \\ AT = {e}^{- γ d} & ( 12 )\end{matrix}$$

As mentioned above, the reflection of noise in each of the first terminal circuit network 31 and the second terminal circuit network 32 is represented by the mode reflection coefficient matrices Sm1 and Sm2, as shown in expression (10). Thus, the propagation of noise circulating through the multiconductor transmission line system 10 is represented as a one-cycle propagation Smc shown in expression (13).

$$\begin{matrix}Expression 13 & \\ Smc = ( Sm 1 \cdot {e}^{- γ d} \cdot Sm 2 \cdot {e}^{- γ d} ) & ( 13 )\end{matrix}$$

In the multiconductor transmission line system 10, the one-cycle propagation Smc is repeated infinitely. That is, the accumulation of multiple reflection propagations is the final propagation. Therefore, the propagation of noise in the multiconductor transmission line system 10 can be represented as the sum of a geometric infinite series matrix, with the one-cycle propagation Smc of expression (13) being a common ratio matrix. Typically, since attenuation occurs in the reflection in the first terminal circuit network 31 and the second terminal circuit network 32, the geometric series matrix does not diverge.

Accordingly, a mode voltage wave vector Am1 of the noise entering the uniform line group 30 from the first terminal circuit network 31 can be expressed as shown in expression (14).

$$\begin{matrix}Expression 14 & \\ Am 1 = {( I - Sm 1 \cdot {e}^{- γ d} \cdot Sm 2 \cdot {e}^{- γ d} )}^{- 1} \cdot Amss & ( 14 )\end{matrix}$$

As shown in expression (15), a mode multiple-reflection infinite series matrix Sms of the multiconductor transmission line system 10 is derived. The sum of the mode multiple-reflection infinite series matrix Sms is a vectorized form of a scalar infinite geometric series. Therefore, the method for deriving the sum of the mode multiple-reflection infinite series matrix Sms is the same as the method for the scalar case.

$$\begin{matrix}Expression 15 & \\ Sms = {( I - Sm 1 \cdot {e}^{- γ d} \cdot Sm 2 \cdot {e}^{- γ d} )}^{- 1} & ( 15 )\end{matrix}$$

The mode multiple-reflection infinite series matrix Sms in expression (15) includes information related to noise propagation for all components of the multiconductor transmission line system 10. The mode multiple-reflection infinite series matrix Sms in expression (15) represents multiple reflections of noise injected into the multiconductor transmission line system 10. Therefore, the noise characteristics of the multiconductor transmission line system 10 can be analyzed using the mode multiple-reflection infinite series matrix Sms.

### Operation and Advantages of Embodiment

The operation and advantages of the analysis method for the multiconductor transmission line system 10 in the present embodiment will now be described.

The multiconductor transmission line system 10, which is subject to the analysis performed in the present embodiment, includes multiple conductor lines (12 and 13) with branches. The presence of the branches make it difficult to analyze noise characteristics. In the present embodiment, the analysis method uses a noise propagation model (propagation model) to analyze the noise characteristics of the multiconductor transmission line system 10. The noise propagation model assumes that the noise signal that has been input into the multiconductor transmission line system 10 propagates while undergoing multiple reflections between the first terminal circuit network 31 and the second terminal circuit network 32 via the uniform line group 30. The noise propagation model assumes that each of the conductor lines (12 and 13) of the multiconductor transmission line system 10 is routed back and forth between the first terminal circuit network 31 and the second terminal circuit network 32, using the change positions for the characteristic impedance as fold-back points. The change positions for the characteristic impedance include the branching sections (20 and 21) from the parallel section 14 for the conductor lines (12 and 13). The uniform line group 30 in the noise propagation model includes the uniform lines 33 to 39 spanning between the first terminal circuit network 31 and the second terminal circuit network 32. The first terminal circuit network 31 and the second terminal circuit network 32 in the noise propagation model include the first to fourth terminal loads 15 to 18, which are already connected to the terminals of the conductor lines (12 and 13), and the fold-back terminal elements, which are already connected to the terminals of the uniform lines 33 to 39. That is, the noise propagation model shown in FIG. 2 is a hypothetical multiconductor transmission line system with which the multiconductor transmission line system 10 in FIG. 1 including multiple uniform lines 33 to 39, which have no branches, is replaced. The uniform lines 33 to 39 extend parallel to each other between the first terminal circuit network 31 and the second terminal circuit network 32. The analysis of the noise characteristics in such a hypothetical multiconductor transmission line system allows for the use of existing analysis methods.

The analysis method of the multiconductor transmission line system 10 in the present embodiment has the following advantages.
(1) In the analysis method of the present embodiment, the multiconductor transmission line system 10, which has branches, is replaced with a hypothetical multiconductor transmission line system without branches. The noise characteristics of the multiconductor transmission line system subsequent to the replacement are analyzed. This simplifies the analysis of the noise characteristics of the multiconductor transmission line system 10, which has branches.
(2) The analysis method of the present embodiment divides each of the first conductor line 12 and the second conductor line 13 into multiple sections based on differences in characteristic impedance. The multiple sections correspond to the uniform lines 33 to 39. Using the analysis method, the noise characteristics in each of these sections can be individually determined. This allows for a detailed analysis of noise characteristics.

### Design Method for Multiconductor Transmission Line System Using Analysis Method of Above-Described Embodiment

The noise characteristics of the multiconductor transmission line system 10 are analyzed using the mode multiple-reflection infinite series matrix Sms of expression (15). The analysis results are reflected in the design of the multiconductor transmission line system 10. This allows for effective designing of the multiconductor transmission line system 10 to suppress the manifestation of noise. Examples 1 to 4 of the design method for the multiconductor transmission line system 10 will now be described.

### Example 1

The line lengths d1 to d7 of the uniform lines 33 to 39 are set such that the line length matrix d=[390, 390, [740, 740], 470, 470, 1], where all units are in millimeters (mm). Such a multiconductor transmission line system 10 is prototyped. In the replacement circuit shown in FIG. 2, the uniform line 39 is arranged for convenience in calculation such that the first terminal circuit network 31 includes the noise source 19. Thus, in this example, the line length d7 of the uniform line 39 is set to a length (e.g., 1 mm) that is sufficiently shorter than the lengths of the other uniform lines 33 to 38. In this prototype, the load resistances of the first to fourth terminal loads 15 to 18 are all set to 50 Ω.

A noise signal is injected into the noise source 19 of the prototype multiconductor transmission line system 10. The noise signal is set such that the terminal voltage of the first conductor line 12 connected to the first terminal load 15 is 1V in the entire frequency band. Measurement was performed for the current flowing through the second branching section 21 in the second conductor line 13 in a state in which the noise signal was injected. A measurement antenna was installed in the vicinity of the prototype. Using the measurement antenna, the electric field strength at the installation point of the measurement antenna was measured. From the measurement results of the current, it was confirmed that the resonance peak of the current existed at 537 Hz. Further, it was confirmed that the electromagnetic waves emitted from the multiconductor transmission line system 10 of the prototype also had a resonance peak at 537 Hz. Electromagnetic waves at 537 Hz may adversely affect the operation of equipment where the multiconductor transmission line system 10 is installed. This creates the need to modify the design of the multiconductor transmission line system 10 to shift the frequency of the current resonance peak from 537 Hz.

The mode multiple-reflection infinite series matrix Sms in expression (15) represents a steady-state of the response from the multiconductor transmission line system 10 to the incident noise signal. Therefore, the eigenvalue of the mode multiple-reflection infinite series matrix Sms represents the natural frequency of the multiconductor transmission line system 10. Thus, the mode multiple-reflection infinite series matrix Sms, which reflects the design values and the noise signals in the multiconductor transmission line system 10 of the above-described prototype, is used. This allows for eigenvalue analysis on the prototype multiconductor transmission line system 10. The results of the eigenvalue analysis are obtained as an eigenvector E for each frequency. The eigenvector E at a specific frequency can be determined in the form shown in expression (16). In expression (16), superscript T denotes the transpose of the vector. That is, in practice, the superscript T indicates that the vector in the expression is a column vector rather than a row vector. Elements e1 to e6 of the eigenvector E correspond respectively to the eigenvalue of the uniform lines 33 to 38. In practice, the eigenvector E also includes an element corresponding to the eigenvalue of the uniform line 39. However, in expression (16), the eigenvalue of the uniform line 39 is omitted.

$$\begin{matrix}Expression 16 & \\ E = {( \begin{matrix}e 1 & e 2 & e 3 & e 4 & e 5 & e 6\end{matrix} )}^{T} & ( 16 )\end{matrix}$$

The maximum value among the elements e1 to e6 of the eigenvector E at a specific frequency is referred to as a maximum eigenvalue. The frequency at which the maximum eigenvalue reaches its peak (i.e., maximum) is referred to as the peak frequency of the maximum eigenvalue. As a result of the eigenvalue analysis, it was confirmed that the peak frequency of the maximum eigenvalue existed at 558 Hz. 558 Hz is relatively close to 537 Hz, which is a problematic current resonance peak frequency. The results of the eigenvalue analysis using the mode multiple-reflection infinite series matrix Sms contain some errors. The errors arise from circuit replacement from the first conductor line 12 and the second conductor line 13 to the uniform line group 30. Due to the errors, the peak frequency of the maximum eigenvalue does not completely match the current resonance peak frequency. However, it is highly likely that the peak frequency of the maximum eigenvalue, which is 558 Hz, is related to the peak frequency of the current and electromagnetic waves, which is 537 Hz.

From the results of the eigenvalue analysis, it was confirmed that among the components e1 to e6 of the eigenvector E at 558 Hz, the elements e1, e4, and e6 were larger than the other elements e2, e3, and e5. Accordingly, it may be effective to modify the characteristic impedance of the uniform lines 33, 36, and 38, which correspond respectively to elements e1, e4, and e6, to shift the peak frequency of 537 Hz. Thus, in this instance, a process was performed to modify the line lengths d1 to d4 of the four uniform lines 33 to 36. The four uniform lines 33 to 36 include two of the uniform lines 33, 36, and 38; specifically, they include the uniform lines 33 and 36. The line lengths d1 to d4 are modified such that the line length matrix d subsequent to the modification becomes [510, 510, [620, 620], 470, 470, 1] (all units are in mm). That is, the initial four values, namely, 510, 510, 620, and 620 are already modified from 390, 390, 740, and 740.

Modifications in the line lengths d1 to d4 are reflected in the mode multiple-reflection infinite series matrix Sms. In the results of the eigenvalue analysis using the modified mode multiple-reflection infinite series matrix Sms, the peak frequency of the maximum eigenvalue deviated from 558 Hz. The multiconductor transmission line system 10 with modified line lengths d1 to d4 were used to measure the current and electromagnetic intensity in the same manner as the prototype multiconductor transmission line system 10. As a result, it was confirmed that the actual current and resonance peak of the electromagnetic wave also deviated from 537 Hz.

To summarize the above, in example 1, the multiconductor transmission line system 10 was designed through the following first to third steps. In the first step, the analysis method of the present embodiment was used to perform the eigenvalue analysis of the uniform lines 33 to 38 of multiple components of the multiconductor transmission line system 10. In the second step, based on the eigenvalue analysis results, uniform lines having a relatively large eigenvalue of a problematic frequency was extracted from the uniform lines 33 to 38. In the third step, for some of the uniform lines that had been extracted, specifically, the uniform lines 33 and 36 in example 1, the design values of uniform lines 33 and 36 were modified such that the characteristic impedance changed. That is, un example 1, the line lengths of the uniform lines 33 and 36 were modified. The characteristic impedance of the uniform lines 33 to 38 can be changed by changing the cross-sectional shapes of the conductors of the uniform lines 33 to 38 or by modifying the heights of the uniform lines 33 to 38 from the ground plane 11. Therefore, the third step may be performed by changing the cross-sectional shape of the conductor of the extracted uniform line or by modifying the height of the extracted uniform line from the ground plane 11.

Alternatively, the multiconductor transmission line system 10 can also be designed by changing the load resistances of the first to fourth terminal loads 15 to 18 as follows. In this case, the first step is to determine the eigenvalues of the first to fourth terminal loads 15 to 18 for each frequency through eigenvalue analysis using the analysis method of the present embodiment. In the second step, the terminal load having a relatively large eigenvalue at the problematic frequency is extracted from the first to fourth terminal loads 15 to 18. The extracted one of the first to fourth terminal loads 15 to 18 is a specific terminal load. In the third step, the load resistance of the specific terminal load is modified such that the characteristic impedance changes.

### Example 2

Regarding example 2, the prototype of the multiconductor transmission line system 10 is set such that the line lengths d1 to d7 of the uniform lines 33 to 39 remain the same between the line length matrix d of example 1 prior to modification and that of example 2. That is, the line length matrix d is [390, 390, [740, 740], 470, 470, 1] (all units are in mm). In example 2, the first to fourth terminal loads 15 to 18 of the prototype all have the load resistance of 50 Ω. In the prototype of the multiconductor transmission line system 10 in example 2, all the uniform lines 33 to 39 are laid at the position of the first height H1, which is fixed, from the ground plane 11.

The following noise signal was injected from the noise source 19 into the prototype of the multiconductor transmission line system 10 in example 2. The noise signal was set such that the terminal voltage of the first conductor line 12, corresponding to a part connected to the first terminal load 15, was 1V in the entire frequency band. A voltage value V3 of the third terminal load 17 and a voltage value V4 of the fourth terminal load 18 in the state in which the noise signal was injected were measured. From the measurement result of the voltage values V3 and V4, the frequencies of a voltage resonance peak were confirmed. The confirmed frequencies include 413 Hz, which is a frequency that adversely affects the operation of a device connected to the second conductor line 13 as the fourth terminal load 18. In other words, 413 Hz is an example of the problematic frequency. This creates the need to modify the design of the multiconductor transmission line system 10 to shift the frequency of the voltage resonance peak from 413 Hz.

From the result of the eigenvalue analysis of this prototype, it was confirmed that the peak frequency of an eigenvalue with the largest absolute value and the peak frequency of an eigenvalue with the second largest absolute value appeared so as to generally overlap the frequency of the voltage resonance peak. The first, fifth, and sixth components e1, e5,and e6 of the eigenvector corresponding to the eigenvalue in which the absolute value is the maximum at 413 Hz indicate larger values than the other components e2 to e4 of this eigenvector. The first, second, and fourth elements e1, e2, and e4 of the eigenvector corresponding to the eigenvalue in which the absolute value is the second largest at 413 Hz indicate larger values than the values of the other elements e3, e5, and e6 of this eigenvector.

To solve the problem, the second largest eigenvalue may be changed at 413 Hz. From the results of the above-described eigenvalue analysis, it may be effective to change the characteristic impedance of the uniform lines 33, 34, and 36. This is because the uniform lines 33, 34, and 36 correspond to the first, second, and fourth elements e1, e2, and e4, respectively. That is, the uniform lines 33, 34, and 36 are specific components of the multiconductor transmission line system 10 that have eigenvalues greater than those of the other components. In the same manner as example 1, the line lengths d1 to d4 of the uniform lines 33 to 36 are modified such that the modified line length matrix d becomes [510, 510, [620, 620], 470, 470, 1] (all units are in mm). That is, the initial four values, namely, 510, 510, 620, and 620 are already modified.

The eigenvalue analysis was conducted using the mode multiple-reflection infinite series matrix Sms that has undergone modifications in the line lengths d1 to d4. The results of the eigenvalue analysis indicated that the frequency of the voltage resonance peak deviates from 558 Hz, which is the peak frequency of the largest eigenvalue. In the multiconductor transmission line system 10 with the modified line lengths d1 to d4, the voltage values V3 and V4 were measured in the same manner as the prototype. As a result, it was confirmed that the voltage resonance peak of the fourth terminal load 18 also deviated from 537 Hz, which is the peak frequency of current and electromagnetic wave.

Instead of modifying the line lengths, the frequency of the resonance peak may be changed by modifying the height of each of the uniform lines 33 to 39 from the ground plane 11. In this case, the multiconductor transmission line system 10 is designed through the following fourth and fifth steps. In the fourth step, the peak frequency of noise for components in the multiconductor transmission line system 10 is calculated using the analysis method of the above-described embodiment. In the fifth step, the height of one or more of the uniform lines 33 to 39 from the ground plane 11 is modified when the calculated peak frequency is a problematic frequency.

### Example 3

By using the mode multiple-reflection infinite series matrix Sms in expression (15), the voltage values of the first to fourth terminal loads 15 to 18 during noise injection can be calculated. By using the results of calculating the voltage values of the first to fourth terminal loads 15 to 18, the multiconductor transmission line system 10 can be designed to reduce specific frequency components of the noise voltage at one of the first to fourth terminal loads 15 to 18.

From expression (15), the mode voltage wave vector Am1 of the noise entering the uniform line group 30 from the first terminal circuit network 31 can be determined. Noise that has entered the uniform line group 30 from the first terminal circuit network 31 propagates through the uniform line group 30, thereby entering the second terminal circuit network 32. As described above, the attenuation and phase lag of noise in the noise propagation in the uniform line group 30 can be represented by the vector AT in expression (12). The noise that exits the first terminal circuit network 31, propagates through the uniform line group 30, and finally enters the second terminal circuit network 32 has a mode voltage wave vector Bm2. The mode voltage wave vector Bm2 is obtained as shown in expression (17).

$$\begin{matrix}Expression 17 & \\ Bm 2 = {e}^{- γ d} \cdot Am 1 & ( 17 )\end{matrix}$$

The noise that enters the second terminal circuit network 32 from the uniform line group 30, is reflected in the second terminal circuit network 32, and finally re-enters the uniform line group 30 has a mode voltage wave vector Am2. The mode voltage wave vector Am2 can be expressed using the mode reflection coefficient matrix Sm2 in the second terminal circuit network 32, as shown in expression (18).

$$\begin{matrix}Expression 18 & \\ Am 2 = Sm 2 \cdot Bm 2 & ( 18 )\end{matrix}$$

Further, noise that propagates through the uniform line group 30 and re-enters the first terminal circuit network 31 has a mode voltage wave vector Bm1. The mode voltage wave vector Bm1 is represented using the vector AT from expression (12), as shown in expression (19). The vector AT in expression (12) indicates the attenuation and phase lag of noise resulting from the noise propagation in the uniform line group 30.

$$\begin{matrix}Expression 19 & \\ Bm 1 = {e}^{- γ d} \cdot Am 2 & ( 19 )\end{matrix}$$

Based on the above, all incident voltage waves and reflected voltage waves for the first terminal circuit network 31 and the second terminal circuit network 32 are obtained. From these parameters, mode voltage vectors Vm1 and Vm2 of the first terminal circuit network 31 and the second terminal circuit network 32 are obtained. The mode voltage vector Vm1 of the first terminal circuit network 31 is expressed as the sum of the mode voltage wave vector Am1 and the mode voltage wave vector Bm1 (Vm1=Am1+Bm1). The mode voltage vector Vm2 of the second terminal circuit network 32 is expressed as the sum of the mode voltage wave vector Am2 and the mode voltage wave vector Bm2 (Vm2=Am2+Bm2). The voltage values of the first to fourth terminal loads 15 to 18 can be calculated by multiplying the mode voltage vectors Vm1 and Vm2 by a mode conversion matrix Pv. In example 3, the multiconductor transmission line system 10 is designed using the calculation results of these voltage values.

Regarding example 3, a comparative study is conducted on design proposals for two types of multiconductor transmission line systems 10, namely, design proposals 1 and 2. The difference between design proposals 1 and 2 lies solely in the height of the single-line section corresponding to the uniform line 33 in FIG. 2 from the ground plane 11. The single-line section corresponding to the uniform line 33 is included in the second conductor line 13. In other words, the height of the single-line section corresponding to the uniform line 33 in design proposal 1 from the ground plane 11 is the first height H1. The height of the single-line section corresponding to the uniform line 33 of design proposal 2 from the ground plane 11 is the second height H2. In the multiconductor transmission line system 10 subject to design, it has been confirmed that noise at 500 MHz adversely affects the operation of the device (fourth terminal load 18) connected to the second conductor line 13. Thus, a process that determines whether design proposal 1 or 2 is better according to the magnitude of the noise of 500 MHz generated in the fourth terminal load 18 will now be described.

In the comparative study, first, for each of the multiconductor transmission line systems 10 in design plans 1 and 2, the voltage value of the fourth terminal load 18 was calculated using the above-described analysis method in a case in which the same noise signal was incident in design plans 1 and 2. As a result, it was confirmed that in design proposals 1 and 2, there existed a bandwidth in which the frequency characteristics of the noise generated by the fourth terminal load 18 differed significantly from each other. At the problematic frequency of 500 MHz, the noise magnitude of design proposal 1 was smaller than that of design proposal 2. Thus, design proposal 1 was adopted.

### Example 4

In example 4, three prototypes of the multiconductor transmission line system 10, namely, prototypes 1 to 3, were prepared. The difference between prototypes 1 to 3 lies solely in the height of the first conductor line 12 and the second conductor line 13, which are laid on the ground plane 11, from the ground plane 11. That is, in the multiconductor transmission line system 10 of prototype 1, the entirety of the first conductor line 12 and the second conductor line 13 is laid at the position of the first height H1 from the ground plane 11. In the multiconductor transmission line system 10 of prototype 2, the entirety of the first conductor line 12 and the second conductor line 13 is laid at the position of the second height H2 (>H1) from the ground plane 11. In the multiconductor transmission line system 10 of prototype 3, the entirety of the first conductor line 12 and the second conductor line 13 is laid in close contact with the ground plane 11.

In example 4, for each of prototypes 1 to 3, the noise voltage of the fourth terminal load 18 was calculated using the analysis method of example 3. Further, for each of prototypes 1 to 3, the noise voltage of the fourth terminal load 18 was measured. The measured noise voltage was compared with the noise voltage obtained from the results of computation using the analysis method. As a result, in prototype 1, except for certain frequency bands, the computation results generally matched the measurement results. By contrast, in prototypes 2 and 3, in more than half of the frequency bands, the calculation results significantly deviated from the measurement results.

This is considered to be due to the following reason. When a conductor line is laid at a position farther than a certain distance from the ground plane 11, the coupling between the conductor of the conductor line and the ground plane 11 may be relatively weak. Additionally, the emission from the conductor line may increase. Thus, if the height of the conductor line from the ground plane 11 is greater than a certain height, the noise characteristics analysis results obtained using the analysis method of the above-described embodiment are likely to diverge from the measurement results. If the conductor line is laid in close contact with the ground plane 11, the distance between the conductor of the conductor line and the ground plane 11 is determined by the thickness of a coated dielectric of the conductor line. In this case, the noise characteristics can vary significantly due to deformation of the coated dielectric. Thus, the analysis results are likely to diverge from the measurement results.

From the comparison between the above-described analysis and measurements, the inventors of the present application found that the height of the conductor line of the multiconductor transmission line system 10 from the ground plane 11 is desirably set to satisfy the following requirements 1 and 2. Requirement 1 is that the height of the conductor line from the ground plane 11 is at least twice the thickness of the coated dielectric of the conductor line. Requirement 2 is that the height of the conductor line from the ground plane 11 is sufficiently smaller than the wavelength of the noise signal at the maximum frequency among the noise signals to be analyzed. Requirements 1 and 2 define the valid scope of application for the analysis method of the above-described embodiment.

### Modifications

The analysis method of the above-described embodiment and the design method of each of the above-described examples may also be employed in a multiconductor transmission line system having a configuration different from that of FIG. 1. A multiconductor transmission line system only needs to include conductor lines and branches of the conductor lines. For example, the analysis method of the above-described embodiment and the design method of each of the above-described examples can be employed in a multiconductor transmission line system including three or more conductor lines and in a multiconductor transmission line system having parallel sections. Configurations 1 and 2 of the multiconductor transmission line system, to which the analysis method of the above-described embodiment can be employed, will now be described.

### Configuration 1

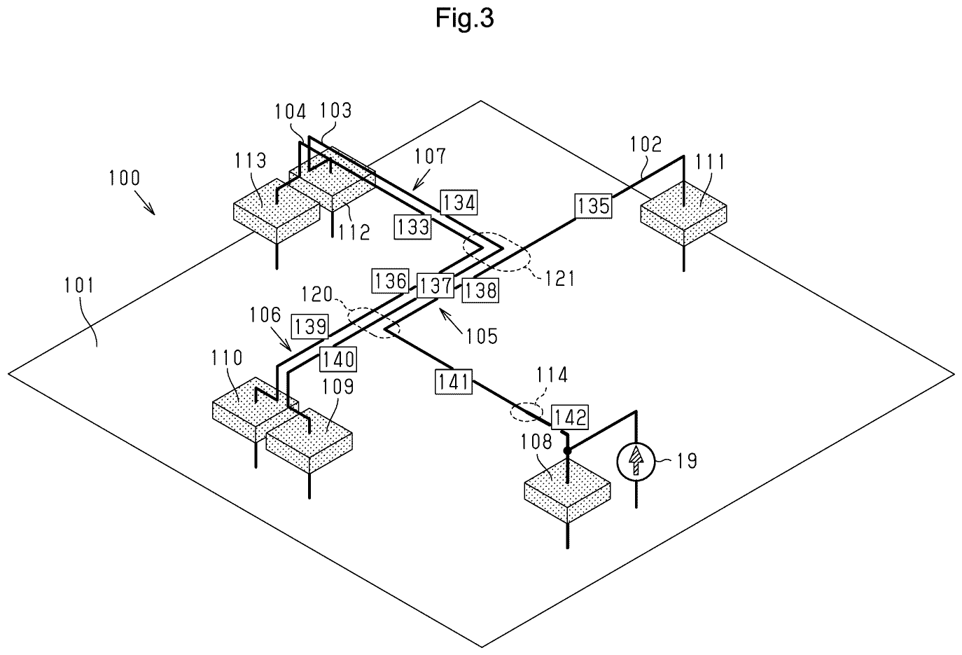

As shown in FIG. 3, the multiconductor transmission line system 100 in configuration 1 includes a ground plane 101 and three conductor lines. The three conductor lines include a first conductor line 102, a second conductor line 103, and a third conductor line 104. In this multiconductor transmission line system 100, the second conductor line 103 and the third conductor line 104 are laid out in close contact with each other and in parallel to each other along their entire lengths. Further, the multiconductor transmission line system 100 includes a three-line parallel section 105, where the first to third conductor lines 102 to 104 are arranged in parallel. The two ends of the three-line parallel section 105 are a first branching section 120 and a second branching section 121. The first branching section 120 branches into a single-line section and a two-line parallel section 106. The single-line section includes the first conductor line 102. In the two-line parallel section 106, the second conductor line 103 and the third conductor line 104 are arranged in parallel. The second branching section 121 branches into a single-line section and a two-line parallel section 107. The single-line section includes the first conductor line 102. In the two-line parallel section 107, the second conductor line 103 and the third conductor line 104 are arranged in parallel. Two terminals of the first conductor line 102 are grounded to the ground plane 11 via the corresponding terminal loads 108 and 111, respectively. Two terminals of the second conductor line 103 are grounded to the ground plane 11 via the corresponding terminal loads 109 and 112, respectively. Two terminals of the third conductor line 104 are grounded to the ground plane 11 via the corresponding terminal loads 110 and 113, respectively. In the multiconductor transmission line system 100 shown in FIG. 3, the noise source 19 is connected to the terminal of the first conductor line 102 that is connected to the terminal load 108

The cross-sectional shape of the conductor in the first conductor line 102 varies along the single-line section between the first branching section 120 and the terminal load 108. In FIG. 3, the differences in the cross-sectional shape of the conductor of the first conductor line 102 are represented by the variations in the thickness of a line indicating the first conductor line 102. In the following description, the position where the cross-sectional shape of the conductor in the first conductor line 102 is switched is referred to as a change point 114.

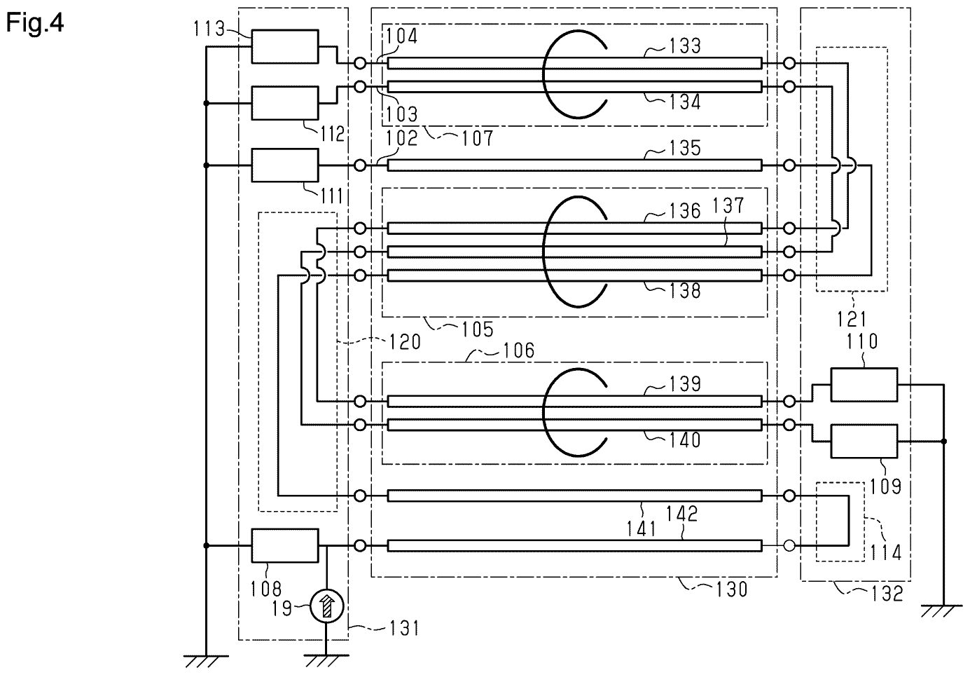

FIG. 4 illustrates the circuit diagram of a replacement circuit obtained after the hypothetical replacement of the multiconductor transmission line system 100 shown in FIG. 3, during the application of the analysis method of the above-described embodiment. In the same manner as the above-described embodiment, the change position for the characteristic impedance includes the first branching section 120 and the second branching section 121, both of which branch from the three-line parallel section 105. The replacement circuit in FIG. 4 is created by hypothetically routing the first conductor line 102 to the third conductor line 104 as follows. The first conductor line 102 to the third conductor line 104 are hypothetically routed back and forth between the first terminal circuit network 131 and the second terminal circuit network 132, using the change position for the characteristic impedance as a fold-back point. In the multiconductor transmission line system 100 shown in FIG. 3, the change position for the characteristic impedance includes not only the first branching section 120 and the second branching section 121, but also the change point 114, where the cross-sectional shape of the conductor of the first conductor line 102 changes. A uniform line group 130 includes ten uniform lines 133 to 142, each having a uniform characteristic impedance throughout its entire length. In FIG. 3, the sections corresponding to the uniform lines 133 to 142 are labeled with the corresponding numbers 133 to 142, respectively. The multiconductor transmission line system 100 in FIG. 3 is hypothetically replaced with the replacement circuit shown in FIG. 4. This allows the mode multiple-reflection infinite series matrix Sms of expression (15) to be employed in the multiconductor transmission line system 100. Thus, the noise characteristics of the multiconductor transmission line system 100 in configuration 1, which is shown in FIG. 3, can also be effectively analyzed using the analysis method of the above-described embodiment.

### Configuration 2

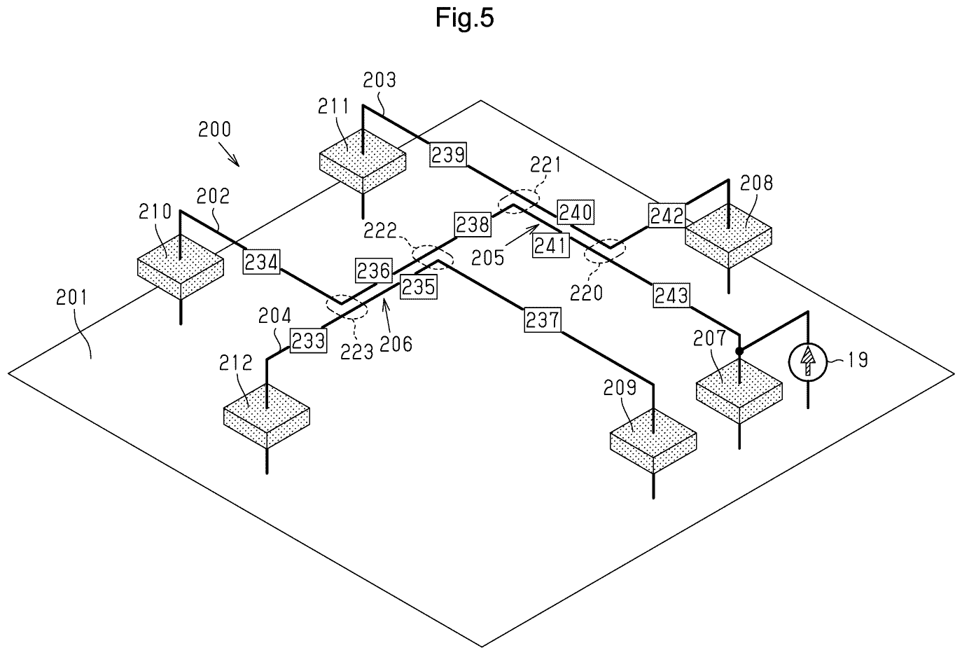

FIG. 5 illustrates a multiconductor transmission line system 200 of configuration 2. The multiconductor transmission line system 200 includes a ground plane 201 and three conductor lines. The three conductor lines include a first conductor line 202, a second conductor line 203, and a third conductor line 204. The multiconductor transmission line system 200 in FIG. 5 includes two parallel sections, namely, a first parallel section 205 and a second parallel section 206. In the first parallel section 205, the first conductor line 202 and the second conductor line 203 are arranged parallel in close contact with each other. In the second parallel section 206, the first conductor line 202 and the third conductor line 204 are arranged parallel in close contact with each other. The two ends of the first parallel section 205 are a first branching section 220 and a second branching section 221. At each of the first branching section 220 and the second branching section 221, the first conductor line 202 and the second conductor line 203 branch off. The two ends of the second parallel section 206 are a third branching section 222 and a fourth branching section 223. At each of the third branching section 222 and the fourth branching section 223, the first conductor line 202 and the third conductor line 204 branch off. Among the first to third conductor lines 202 to 204, only the first conductor line 202 is routed through both the first parallel section 205 and the second parallel section 206. The second conductor line 203 is routed through the first parallel section 205. The third conductor line 204 is routed through the second parallel section 206. Two terminals of the first conductor line 202 are grounded to the ground plane 11 via the corresponding terminal loads 207 and 210, respectively. Two terminals of the second conductor line 203 are grounded to the ground plane 11 via the corresponding terminal loads 208 and 211, respectively. Two terminals of the third conductor line 204 are grounded to the ground plane 11 via the corresponding terminal loads 209 and 212, respectively. In the multiconductor transmission line system 200 shown in FIG. 5, the noise source 19 is connected to the terminal of the first conductor line 202 that is connected to the terminal load 207.

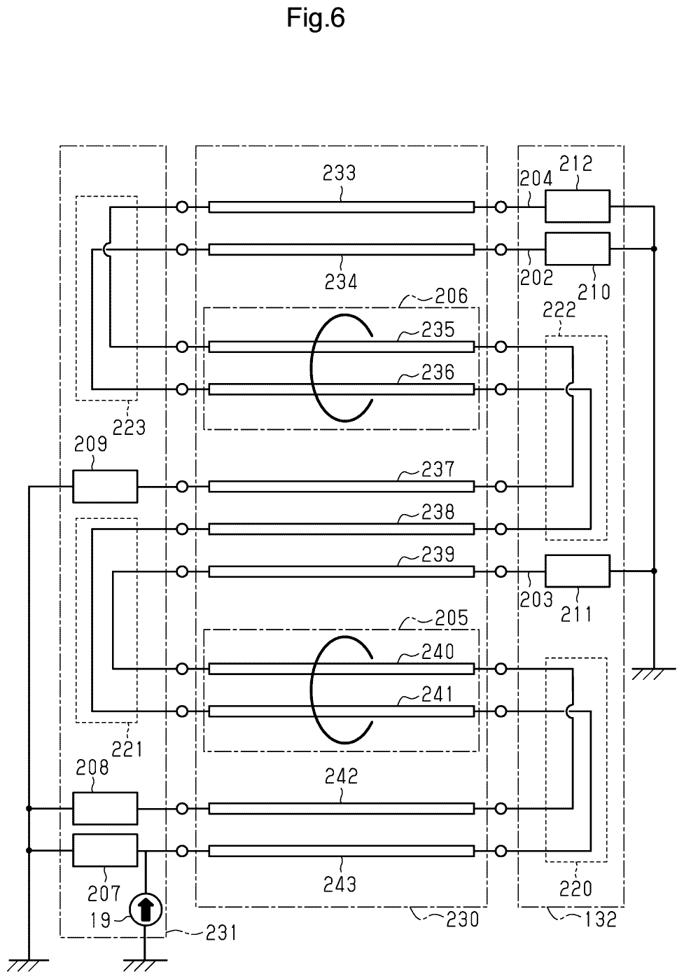

FIG. 6 illustrates the circuit diagram of a replacement circuit obtained after the hypothetical replacement of the multiconductor transmission line system 200 shown in FIG. 5, during the application of the analysis method of the above-described embodiment. In the multiconductor transmission line system 200 shown in FIG. 5, the first conductor line 202 to the third conductor line 204 include the first parallel section 205 and the second parallel section 206. That is, in the first parallel section 205, the first conductor line 202 and the second conductor line 203 are arranged in parallel. In the second parallel section 206, the first conductor line 202 and the third conductor line 204 are arranged in parallel. The first parallel section 205 includes the first branching section 220 and the second branching section 221. The second parallel section 206 includes the third branching section 222 and the fourth branching section 223. The change position for the characteristic impedance of each of the first conductor line 202 to the third conductor line 204 includes the first branching section 220 to the fourth branching section 223. The replacement circuit in FIG. 6 is created by hypothetically routing the first conductor line 202 to the third conductor line 204 as follows. In FIG. 6, the first conductor line 202 to the third conductor line 204 are hypothetically routed back and forth between the first terminal circuit network 231 and the second terminal circuit network 232, using the first to fourth branching sections 220 to 223 as fold-back points. As shown in FIG. 6, the uniform line group 230 includes eleven uniform lines 233 to 243. In FIG. 5, the sections corresponding to the uniform lines 233 to 243 are labeled with the corresponding numbers 233 to 243, respectively. The multiconductor transmission line system 200 of FIG. 5 is hypothetically replaced by the replacement circuit in FIG. 6. This allows the mode multiple-reflection infinite series matrix Sms of expression (15) to be employed in the multiconductor transmission line system 200 of FIG. 5. Thus, the noise characteristics of the multiconductor transmission line system 200 in configuration 2, which is shown in FIG. 5, can also be effectively analyzed using the analysis method of the above-described embodiment.

The control device that executes various computations for noise analysis includes a CPU and a ROM and is not limited to those executing software processes. That is, the control device may be modified as long as it has any one of the following configurations (a) to (c).
(a) The control device includes one or more processors that execute various processes in accordance with a computer program. The processor includes a CPU and a memory, such as a RAM and ROM. The memory stores program codes or instructions configured to cause the CPU to execute the processes. The memory, or a computer-readable medium, includes any type of media that are accessible by general-purpose computers and dedicated computers.
(b) The control device includes one or more dedicated hardware circuits that execute various processes. Examples of the dedicated hardware circuits include an application specific integrated circuit (ASIC) and a field programmable gate array (FPGA).
(c) The control device includes a processor that executes part of various processes in accordance with a computer program and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An analysis method for a multiconductor transmission line system, the analysis method comprising:
providing the multiconductor transmission line system, wherein
the multiconductor transmission line system includes a ground plane and conductor lines,
the multiconductor transmission line system further includes a parallel section in which the conductor lines are arranged parallel to each other,
each of the conductor lines includes a terminal load,
one or more of the conductor lines include one or more branching sections extending from the parallel section, and
the conductor lines include one or more change positions for characteristic impedance that include the one or more branching sections;
assuming a noise propagation model, wherein
the noise propagation model includes a uniform line group, a first terminal circuit network, and a second terminal circuit network, and
a noise signal that has been input into the multiconductor transmission line system is assumed to propagate while undergoing multiple reflections between the first terminal circuit network and the second terminal circuit network via the uniform line group;
assuming routing of the conductor lines in the noise propagation model, wherein
each of the conductor lines is assumed to be routed back and forth between the first terminal circuit network and the second terminal circuit network using the one or more change positions for the characteristic impedance as one or more fold-back points, and
each of the one or more fold-back points includes a fold-back terminal element;
forming the uniform line group by uniform lines, wherein
each of the conductor lines includes the uniform lines spanning between the first terminal circuit network and the second terminal circuit network, and
the uniform line group includes a first group terminal corresponding to the first terminal circuit network and a second group terminal corresponding to the second terminal circuit network;
forming the first terminal circuit network by one or more of the terminal loads connected to the first group terminal and one or more of the fold-back terminal elements connected to the first group terminal;
forming the second terminal circuit network by one or more of the terminal loads connected to the second group terminal and one or more of the fold-back terminal elements connected to the second group terminal; and
analyzing a noise characteristic of the multiconductor transmission line system using the noise propagation model.

2. The analysis method for the multiconductor transmission line system according to claim 1, wherein the ground plane is a conductor body of transportation equipment.

3. The analysis method for the multiconductor transmission line system according to claim 1, wherein the conductor lines are electric wires or busbars.

4. A design method for a multiconductor transmission line system, the design method comprising:
providing the multiconductor transmission line system, wherein
the multiconductor transmission line system includes a ground plane and conductor lines,
the multiconductor transmission line system further includes a parallel section in which the conductor lines are arranged parallel to each other,
each of the conductor lines includes a terminal load,
one or more of the conductor lines include one or more branching sections extending from the parallel section, and
the conductor lines include one or more change positions for characteristic impedance that include the one or more branching sections;
assuming a noise propagation model, wherein
the noise propagation model includes a uniform line group, a first terminal circuit network, and a second terminal circuit network, and
a noise signal that has been input into the multiconductor transmission line system is assumed to propagate while undergoing multiple reflections between the first terminal circuit network and the second terminal circuit network via the uniform line group;
assuming routing of the conductor lines in the noise propagation model, wherein
each of the conductor lines is assumed to be routed back and forth between the first terminal circuit network and the second terminal circuit network using the one or more change positions for the characteristic impedance as one or more fold-back points, and
each of the one or more fold-back points includes a fold-back terminal element;
forming the uniform line group by uniform lines, wherein
each of the conductor lines includes the uniform lines spanning between the first terminal circuit network and the second terminal circuit network, and
the uniform line group includes a first group terminal corresponding to the first terminal circuit network and a second group terminal corresponding to the second terminal circuit network;
forming the first terminal circuit network by one or more of the terminal loads connected to the first group terminal and one or more of the fold-back terminal elements connected to the first group terminal;
forming the second terminal circuit network by one or more of the terminal loads connected to the second group terminal and one or more of the fold-back terminal elements connected to the second group terminal;
analyzing eigenvalues of components of the multiconductor transmission line system by analyzing a noise characteristic of the multiconductor transmission line system using the noise propagation model;
extracting a specific component from the components based on a result of analyzing the eigenvalues, wherein the specific component has an eigenvalue that is greater than the eigenvalues of other ones of the components in a problematic frequency; and
changing a design value of the specific component such that the characteristic impedance of the specific component changes.

5. A design method for a multiconductor transmission line system, the design method comprising:
providing the multiconductor transmission line system, wherein
the multiconductor transmission line system includes a ground plane and conductor lines,
the multiconductor transmission line system further includes a parallel section in which the conductor lines are arranged parallel to each other,
each of the conductor lines includes a terminal load,
one or more of the conductor lines include one or more branching sections extending from the parallel section, and
the conductor lines include one or more change positions for characteristic impedance that include the one or more branching sections;
assuming a noise propagation model, wherein
the noise propagation model includes a uniform line group, a first terminal circuit network, and a second terminal circuit network, and
a noise signal that has been input into the multiconductor transmission line system is assumed to propagate while undergoing multiple reflections between the first terminal circuit network and the second terminal circuit network via the uniform line group;
assuming routing of the conductor lines in the noise propagation model, wherein
each of the conductor lines is assumed to be routed back and forth between the first terminal circuit network and the second terminal circuit network using the one or more change positions for the characteristic impedance as one or more fold-back points, and
each of the one or more fold-back points includes a fold-back terminal element;
forming the uniform line group by uniform lines, wherein
each of the conductor lines includes the uniform lines spanning between the first terminal circuit network and the second terminal circuit network, and
the uniform line group includes a first group terminal corresponding to the first terminal circuit network and a second group terminal corresponding to the second terminal circuit network;
forming the first terminal circuit network by one or more of the terminal loads connected to the first group terminal and one or more of the fold-back terminal elements connected to the first group terminal;
forming the second terminal circuit network by one or more of the terminal loads connected to the second group terminal and one or more of the fold-back terminal elements connected to the second group terminal;
calculating a peak frequency of noise in one or more of components of the multiconductor transmission line system by analyzing a noise characteristic of the multiconductor transmission line system using the noise propagation model, wherein each of the uniform lines has a height from the ground plane; and
changing one or more of the heights when the peak frequency is a problematic frequency.
